(19) United States
(12) Patent Application Publication
(10) Pub. No.: US 2011/0235044 A1
(43) Pub. Date: Sep. 29, 2011

(54) Welch certainty principle continued

(76) Inventor: James D. Welch, Omaha, NE (US)

(21) Appl. No.: 13/066,755

(22) Filed: Apr. 25, 2011

Related U.S. Application Data
(63) Continuation-in-part of application No. 12/806,521, filed on Aug. 16, 2010, now abandoned.
Application No. 12/806,521 is a continuation-in-part of application No. 12/387,450, filed on May 4, 2009, now abandoned.
(60) Provisional application No. 61/397,156, filed on Jun. 9, 2010.
(60) Provisional application No. 61/399,165, filed on Jul. 8, 2010.
(60) Provisional application No. 61/458,596, filed on Nov. 29, 2010.
(60) Provisional application No. 61/464,123, filed on Feb. 28, 2011.
(60) Provisional application No. 61/465,856, filed on Mar. 26, 2011.

(51) Int. Cl. G01B 9/02

(52) U.S. Cl. 356/450

(57) ABSTRACT

It is proposed that the Heisenberg Uncertainty Principle is a system-specific concept, and that using a reference Interference Pattern, or applying chaos concepts to the situation at the slits of a double slit system leads to the proposal that a photon or particle that contributes to a positive slope region in an interference pattern formed by a double slit system is more likely to have passed through the left slit of the double slit system, (as viewed from the source), and a particle or photon which contributes to a negative slope region of the interference pattern is more likely to have passed through the right slit thereof (again as viewed from the source). Further, an experiment comprising use of a laterally, (and/or perpendicular thereto), movable screen upon which particles impinge is proposed that, in the context of a double slit system, would allow verification of the proposal, and which would also, allow near-simultaneous measurement of particle position and momentum.

This application is a CIP of Ser. No. 12/806,521 Filed Aug. 16, 2010; and of Pending application Ser. No. 12/387,450 Filed May 4, 2009, and there via Claims Benefit of 61/211,514 Filed Mar. 31, 2009. This application also directly Claims benefit of 61/397,156 Filed Jun. 9, 2010 and directly Claims benefit of 61/399,165 Filed Jul. 8, 2010 and of 61/458,596 Filed Nov. 29, 2010, 61/464,123 Filed Feb. 28, 2011 and of 61/465,856 Filed Mar. 26, 2011.

### TECHNICAL FIELD

The present invention relates to how physical system-specific characteristics might challenge the absolute nature attributed to the uncertainty principal, thereby making uncertainty a system-specific concept, and more particularly applies chaos concepts to the situation at the slits of a double slit system with the proposal that a photon or particle that contributes to a positive slope region in an interference pattern formed by a double slit system is more likely to have passed through the left slit of the double slit system, (as viewed from the source), and a particle or photon which contributes to a negative slope region of the interference pattern is more likely to have passed through the right slit thereof. An experiment is proposed that would allow verification thereof, and which would allow near-simultaneous measurement of particle position and momentum.

### BACKGROUND

It is generally considered that the Heisenberg Uncertainty (ISSN 1798-2448).

Said articles provide good insight to the progression in thought that has led to the present invention, and are incorporated herein by reference.

A reference that explains how the uncertainty principle applies to a double slit system, is Chapter 37 of the “Lectures On Physics”, Addison Wesley, 1963, Feynman describes an experiment proposed by Heisenberg, with an eye to overcoming the Uncertainty Principle. The idea involves placing a plate containing double slits on rollers so that if a particle passes through one slit thereof, it will transfer momentum to the plate in one direction, and if it passes through the other slit momentum will be transferred to the plate in the opposite direction. It is proposed that this momentum transfer could be monitored to determine, through which slit the particle passed. The problem that presents, however, is that the slit location then becomes uncertain. Again, the proposed approach does nothing to challenge the Uncertainty Principle. Feynman concludes Chapter 37 by saying that no one has been able to measure both position and momentum of anything with any greater accuracy than that governed by the Uncertainty Principle, but in a recorded lecture added that someone, sometime might figure it out, (which served as my encouragement to try, leading to the disclosure herein).

Batelaan, in Chp. 2 of Wave-Particle Duality with Electrons, the Perimeter Inst. (2011) states that to date no-one knows what a particle does in a double slit system.

An article by Mittelstaedt et al. titled Unsharp Particle-Wave Duality in a Photon Split-Beam Experiment, of Quantum Mechanics, is an absolute. This is based in Fourier Transform-type mathematics, and to the authors knowledge is never modified by known characteristics of a physical system to which it is applied. It is argued herein that characteristics of a physical system to which the uncertainty principal is applied can serve to render the uncertainty principal less than absolute.

Continuing, the Heisenberg Uncertainty Principle holds that uncertainty in a measurement of a photon or particle's position times the uncertainty of a measurement of its momentum must always exceed a quantity closely related to Planks constant. Further, it is generally considered that the Heisenberg Uncertainty Principle governs formation of an interference pattern when photons or particles are directed toward a double slit system, such that at least some of them pass through a slit and impinge on a screen. In particular, as the momentum of a photon or particle directed toward the slits can be set with arbitrary accuracy, based on the uncertainty principle it is generally believed that it is impossible to know anything about through which slit it passes. Further, as it is possible to measure where on a screen a photon or particle impinges with arbitrary accuracy, it is generally accepted that it is impossible to know anything about its lateral momentum, hence through which slit passed.

Two very relevant articles are titled:
“The Uncertainty of Uncertainty”, Welch, ISAST Transactions on Computers and Intelligent Systems, No. 2, Vol. 2, 2010 (ISSN 1798-2448); and
“The Welch Certainty Principle”; ISAST Transactions on Computers and Intelligent Systems, Vol. 3, No. 1, 2011
   Foundations of Physics, Vol. 17, No. 9, 1987 is identified. This article reported that in a quantum mechanics two-slit experiment one can observe a single photon simultaneously as a particle (measuring the path), and as a wave (measuring the interference pattern) if the path and interference pattern are measured in the sense of unsharp observables. However, it is noted that the interference pattern is altered by the Mittelstaedt et al. approach, therefore, uncertainty in the photon momentum is increased. This experiment therefore does nothing to challenge the Uncertainty Principle

Another reference, Optics, Hecht, Addison-Wesley, 1987 is also disclosed as in Chapter 10 thereto, it provides an excellent mathematical description of the Double Slit experiment.

Other known references include:
“Particle Physics for Non-Physicists: A Tour of the Microcosmos”; Pollock, The Teaching Co. (2003); and
Warped Passages; Lisa Randall, Harper Collins, 2005, ppg. 133-35.
The Grand Design; Stephen Hawking, Bantum Books, 2010, ppg. 63-66, 68, 70, 83, 135-36.
The Hidden Reality; Brian Greene, Alfred A. Knopf, 2010, ppg. 193-95, 205.

### DISCLOSURE OF THE INVENTION

The present invention is a method of determining through which slit of a double slit system a particle passes, or at least is more likely to have passed, in formation of an interference pattern comprising the steps of:
a) providing a double slit system which comprises:
   a′) a source of particles;
   a″) a barrier having two slits therein;
   a′″) a screen.
      In use a particle is caused by said source thereof to approach and pass through a slit in said barrier, then impinge on said screen; and such that when a multiplicity of particles are so caused to pass through one or the other slit in said barrier, then impinge on said screen, an interference pattern emerges, said interference pattern having positive and negative slopes on both sides of a center point of said interference pattern.

Said screen further has means for allowing lateral motion in response to momentum transfer from an impinging particle.

The method continues with:
b) causing said source to project a particle toward said barrier such that it passes through one of the slits and impinges said screen in a manner allowing the position at which is impinges to be identified, as well as how far said screen moves laterally in response to momentum being transferred thereto.
   Said method further comprises:
c) determining that for particles contributing to positive slope regions in the interference pattern to the right of said interference pattern central region and for particles contributing to negative slope regions in the interference pattern to the left of said interference pattern central region that the screen lateral motion is greater than for particles contributing to negative slope regions in the interference pattern to the right of said interference pattern central region and for particles contributing to positive slope regions in the interference pattern to the left of said interference pattern central region; and
concluding therefrom that on both sides of the central region of the interference pattern, particles contributing to positive slope regions predominantly pass through the left slit and that particles contributing to negative slope regions predominantly pass through the right slit, said systems right and left being as viewed from said source.

Another present invention method comprising the steps of:
a) providing a double slit system which comprises:
   a′) a source of particles;
   a″) a barrier having two slits therein;
   a′″) a screen.
      In use a particle is caused by said source thereof to approach and pass through a slit in said barrier, then impinge on said screen.

Said screen further has means for allowing motion perpendicular to a lateral locus of said screen in response to momentum transfer from an impinging particle.

Said method further comprises:
b) causing said source to project a particle toward said barrier such that it passes through one of the slits and impinges said screen in a manner allowing the position at which is impinges to be identified, as well as how far said screen moves perpendicular to a lateral locus of said screen in response to momentum being transferred thereto.

### Further,

c) determining how far the screen moves perpendicular to said lateral locus thereof in response to a particle impinging thereupon; and
concluding therefrom the location on said screen upon which the particle impinged, and its momentum from the motion thereof how far the screen moves perpendicular to said lateral locus thereof in response to a particle impinging thereupon.

The present invention will be better understood by reference to the Detailed Description Section of the Specification, in combination with the Drawings.

### BRIEF DESCRIPTION OF THE DRAWINGS

FIG. 1 shows Fourier transforms of a Normal Distribution.

FIGS. 2a and 2b show the condition where one of a Fourier Transform pair is an infinite peak, and the other a distribution with an infinite uncertainty.

FIG. 3 shows an Application of a double slit system to provide knowing with improved probability which slit a photon or particle passes in a double slit system while still forming an interference pattern.

FIG. 4 shows an example of the Welch Certainty Principle.

FIGS. 5a and 5b show important slopes in the application of the Welch Certainty Principle.

FIG. 6 shows a well known pattern of interfering wavelets, wherein, simultaneously, one thereof passes through a left slit of a double slit system and the other through the right slit thereof.

FIG. 7 demonstrates how a photon or particle passing through a slit, in view chaos effects based on initial conditions as to where in the width of the slit the photon or particle is as it passes therethrough, will be more likely to follow along an (M=0), (M=1) or (M=2) etc. path.

FIGS. 8a, 8b and 8c show that a likely consequence of this is that a photon or particle exiting the left slit (SLL) will contribute to a positive slope region in an interference pattern and that a photon or particle exiting the right slit (SLR) will contribute to a negative slope region in an interference pattern as was determined with respect to the after the fact scenario wherein a reference interference pattern on a reference screen (SC) was applied to determine the same conclusion.

FIG. 9 demonstrates a possible approach to invaliating the Welch Certainty Principle.

### DETAILED DESCRIPTION

### Macroscopic System Considerations

To begin, it is of benefit to consider that if one measures the exact position of an object at an exact instant in time, it is literally impossible to know how fast the object might be moving because at an exact instant in time no time passes. At the exact instant of measurement the object could be standing still, moving at near the speed of light, or moving at any velocity in between, because at the precise instant of measurement, there is no information available to allow determination of its velocity, (ie. some time must pass for a velocity to be measured). Likewise, if an object is moving it is present at a continuum of locations when that velocity is measured, hence there is no way to define exactly where it is located while measuring velocity. As the velocity scenario might be a bit more difficult to grasp, it is further noted that to measure how fast an object is moving, you necessarily have to measure the location of that object at, at least, two instants of time and you need to know how much time elapsed between the two location measurements. However, while having such information lets you calculate the ---average--- velocity at which the object was moving between said two measured locations, such information does not tell you what its exact velocity was at a particular point between the measurement locations, or anywhere else for that matter. This is because the object could have been slowing down or speeding up, (or a combination thereof), between the two precise measurements of the locations and the same average velocity would be arrived at in many different cases. Therefore it remains unknown what the precise velocity was at any precise position. The only apparent approach to minimizing this problem is to make the two precise measurements of the object position very close to one another, thereby minimizing the effect of change in velocity therebetween very small. However, as long as some distance exists between the measurement locations this approach cannot guarantee that the velocity was not changing between said precise location measurements. And in the limit, where the distance between location measurements becomes dx=0.0 so that no velocity change occurs, we again arrive back at the problem that a precisely measured position provides no information as to velocity, as described the start of this paragraph. (Note, that the objects velocity can be multiplied by its mass, and the term velocity replaced by momentum in the foregoing). In view of the foregoing, even on a macroscopic object level, the seeds of an uncertainty as regards the ability to simultaneously measure both the precise location and the precise velocity of a moving object, can be appreciated. While the foregoing scenario is, as a practical matter, not particularly troublesome to people in their every day lives where knowing an average velocity is normally more than sufficient, it does becomes a major source of indeterminacy when very small objects are involved. In fact, it is generally accepted in Quantum Mechanics that it makes no sense to even ask what the position ---and--- the momentum of a particle are simultaneously. That is, a particle can be observed to have one or the other, but not both a position and-- a momentum simultaneously. In fact, it is generally accepted that if one measures the position of a particle exactly, then the uncertainty as to what its momentum is at that time, is infinite. And likewise, if one measures the exact momentum, then the uncertainty in the position thereof is infinite.

### Fourier Transform Math

When one surveys mathematical functions that provide an amplitude, and another parameter that assumes a larger value when a related parameter assumes a smaller value, Fourier Transforms should come to mind. This is because when the width (standard deviation) of one member of a Fourier Transform pair of functions becomes narrower, the standard deviation of the other member increases in width, and vice versa. For instance, Fourier Transformation:

f(t)=e^{-at2}

F(ω)=(π/a)^{1/2}e^{-ω2/2a}

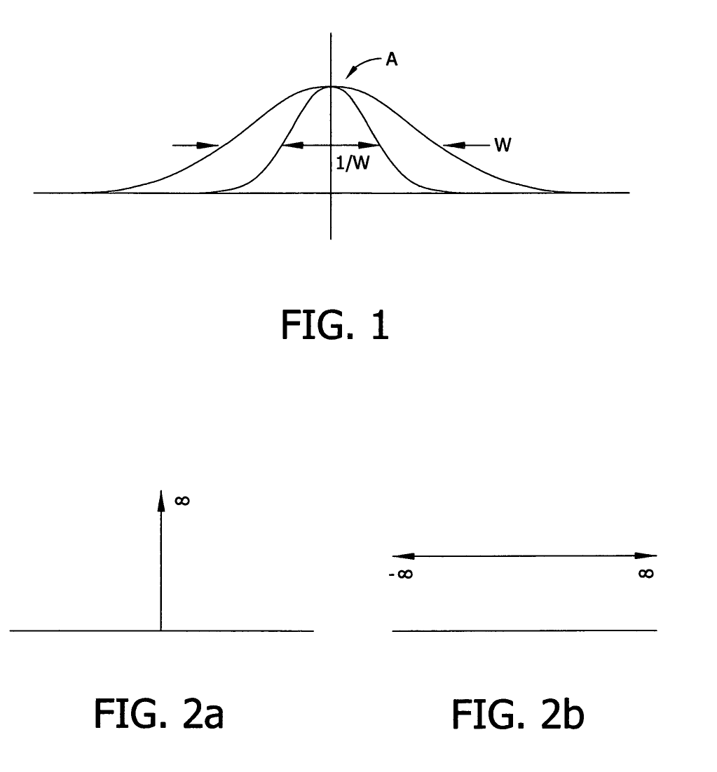

can be applied to a Normal Distribution, (which is characterized by a peak amplitude (A) in a bell shaped plot, and by a Standard Deviation that indicates its width (W)) and the result is another Normal Distribution that has a standard deviation of (1/W). FIG. 1 qualitatively shows this for the case where a=( ) so that the amplitudes for both distributions are the same. The important result is that the product of the standard deviations of two Fourier Transform pairs is, for the normal distribution, one 1.0. For other functions said product can also be greater than one 1.0. It is noted that if one of a Fourier Transform pair of functions has a Standard Deviation of zero 0.0, then the other has a Standard Deviation of infinity. One can view a zero 0.0 wide Standard Deviation, infinite amplitude function as representing an exact object position or velocity, and the Fourier Transformed function thereof will have a Standard Deviation width of infinity, implying infinite uncertainty in knowledge of its conjugate velocity or position, respectively.

FIGS. 2a and 2b below demonstrate the sort of results that one obtains when applying mathematical approach just disclosed.

### Quantum Considerations

Continuing, while Fourier Transform mathematics is just that, mathematics, the approach demonstrated thereby has been adopted in Quantum Mechanics to characterize Conjugate Variables, (eg. position (X) and Momentum (P), or Energy (E) and Time (T), or Spatial Field Strength (FS) and Rate of Change of thereof (d(FS)/dt). As applied in quantum mechanics, FIG. 2a can, for instance, represent a probability distribution for an exactly measured location or momentum, (ie mass×velocity (mv)), of a particle. That is, there is no uncertainty as regards the indicated value at all, (ie. the width of the distribution is zero 0.0). FIG. 2b shows the resulting distribution for the conjugate momentum or location, respectively. Note that FIG. 2b shows it is equally likely that the momentum or location can be anywhere. That is, the width of the distribution infinite (∞), hence its uncertainty is also infinite (∞). This is the postulate throughout quantum mechanics. When the distribution of one of a pair of conjugate variables has a zero 0.0 width distribution, the other has an infinite (∞) width distribution. To the authors knowledge this is not ever modified based on characteristics of a physical system in quantum theory.

### Dice

In the foregoing it was shown how uncertainty concepts can be understood based in macroscopic examples. Table 1 presents another relevant macroscopic example involving the results obtained by the throwing of two dice, which can result in a sum of 2, 3, 4, 5, 6, 7, 8, 9, 10, 11 or 12. It is further known that there are probabilities associated with obtaining said results:

TABLE 1

| | | CHANCE |
|---|---|---|
| RESULT | WAYS TO OBTIAN | OF EACH |
| 2 | 1 + 1 | 1/1 |
| 3 | 1 + 2, 2 + 1 | 1/2 |
| 4 | 1 + 3, 2 + 2, 3 + 1 | 1/3 |
| 5 | 1 + 4, 2 + 3, 3 + 2, 4 + 1 | 1/4 |
| 6 | 1 + 5, 2 + 3, 3 + 3, 3 + 2, 5 + 1 | 1/5 |
| 7 | 1 + 6, 2 + 5, 3 + 4, 4 + 3, 5 + 2, 6 + 1 | 1/6 |
| 8 | 2 + 6, 3 + 5, 4 + 4, 5 + 3, 6 + 2 | 1/5 |
| 9 | 3 + 6, 4 + 5, 5 + 4, 6 + 3 | 1/4 |
| 10 | 4 + 6, 5 + 5, 6 + 4 | 1/3 |
| 11 | 5 + 6, 6 + 5 | 1/2 |
| 12 | 6 + 6 | 1/1 |

Now, if one measures only the sum total of the results of throwing two dice, it becomes readily apparent that, other than for the values of 2 and 12, one can not be absolutely certain what each of the dice contribute. That is, the measurement per se. does not disclose how the measured result was arrived at. However, by analyzing the system that produced the measured result, one can know that a certain result, (eg. 7), was arrived at by a selection from a known group of six definite possibilities, (a chance for each of (⅙)). Notice also, that if a 3, 4 or 5 was measured it is known with certainty, by analysis of the system involved, that neither die showed a 4, 5 or 6, respectively. Further, if a 3 or 11 results, note that one can not determine which dice has the 2 or 5 and which has the 1 or 6, from the sum total. One can, however, tell a lot about what information is imparted by a measurement provided by a system, by analyzing the physical system involved to determine how it could produce various measured results, and a probability can be assigned to specific results in view thereof.

### The Double Slit System

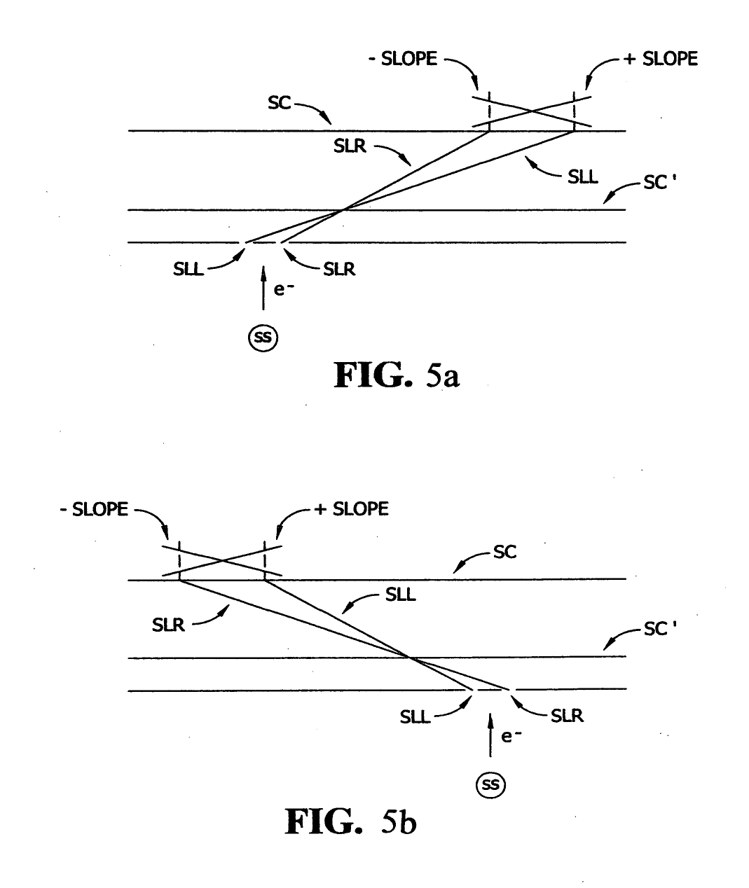

The dice example described in the Disclosure Section shows that knowledge of a system can provide inferred knowledge about it, which is not subject of direct measurement. In that light, it is noted that in an article titled The Welch Uncertainty Principal, ISAST Vol. 1, No. 3, 2011, Welch proposes that the physical characteristics of a Double Slit system allow inferring that it is more likely that a photon or particle which impinges on a screen thereof can be determined to more likely have passed through one of the slits than the other. As described in the cited articles, the described result can be understood by considering that a reference interference pattern can formed on a reference screen (SC) by firing a large number of photons or particles thereat through, respectively, left and right double slits (SLL) and (SLR), and the resulting interference pattern can be fixed in place as a reference. This is followed by placing a test screen (SC) just in front of said reference screen (SC), and firing a single photon or particle thereat, and noting where thereupon it impinges. Next, lines are projected from each slit (SLL) and (SLR) through said location at which the single photon or particle impinged upon the test screen (SC). When this is done it will be found that one of said projected lines intercepts the reference interference pattern on the reference screen (SC) at a higher probability location, and that indicates which slit (SLL) (SLR) it is more likely that the single photon or particle passed. When this approach is repeated with many photons or particles, it is found that it is always more likely that a photon or particle which contributes to a positive slope region of the test screen is always more likely to have passed through the left slit, (as viewed from a source of photons or particles), and that a photon or particle that contributes to a positive slope region of an interference pattern is more likely to have passed through the right slit, (again as viewed from a source of photons or particles), if it impinges contributes to a negative slope region of an interference pattern. And, as the distance between the reference (SC) and test (SC) screens can be reduced to zero (0.0), FIG. 5 can be presented to demonstrate what has been termed the Welch Certainty Principle. Unlike in the case described above wherein two dice provides a measured sum total of 3 or 11, and in which the system of dice provides no way to discern which of the pair shows a 1 or a 5, respectively, in the case of the double slit system, the system-specific characteristics do provide a basis for greater insight.

FIG. 5 indicates that during formation of an interference pattern, if a photon or particle contributes to a positive (+)/(−) slope region it is more likely it passed through the (SLL)/(SLR) slit, respectively. FIG. 5 shows that the physical system-specific characteristics of the double slit system provides a basis that makes it possible to determine, with greater probability than predicted by the purely mathematical based uncertainty principal, through which slit of a double slit system it is more likely a photon or particle passed. That is, the uncertainty principal holds that since it is possible to measure where a photon or particle intercepts the test screen (SC) with unlimited accuracy, one can have absolutely no knowledge as to what its momentum was at that point of measurement. This includes lateral momentum, so that knowing the exact location of the photon or particle on the test screen (SC) precludes knowing through which slit (SLL) (SLR) it passed. Otherwise stated, FIG. 2a can be taken to represent the location, and FIG. 2b the lateral momentum of the photon or particle. But based on the double slit system-specific characteristics, it can be concluded that one can something more than the purely mathematical uncertainty principle allows about which slit (SLL) (SLR) through which the photon or particle passed, in contributing to formation of an resulting interference pattern on the test screen (SC). It is also noted that in the context of the double slit system, an approach to measuring both position and momentum of a particle would involve providing a test screen (SC) that can move laterally to the left and right, (but with the requirement that it return to a central location between tests), and firing a particle (the more massive the better) thereat. When the particle first impinges on the test screen (SC) its position is indicated, and as it transfers its momentum to the test screen (SC) a detectable motion thereof will indicate the momentum it had at the time of said impingement. Note that if such an experiment can be conducted, it would directly contradict and overturn the Heisenberg Uncertainty Principle.

### Challenge to the Uncertainty Principle

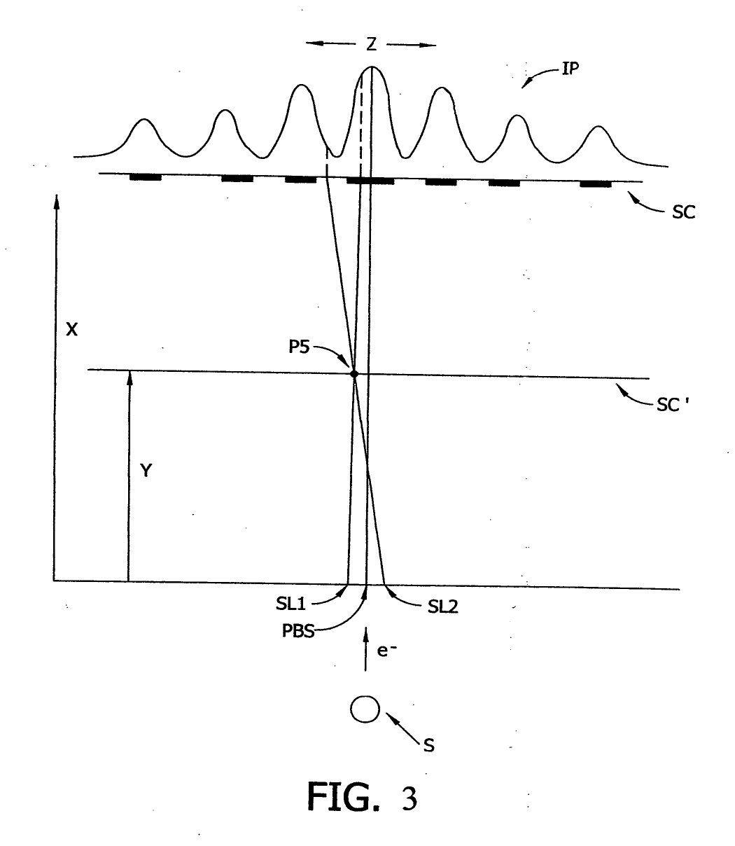

Continuing, in a letter published in the ISAST Transactions on Computers and Intelligent Systems, No. 2, Vol. 2, 2010 (ISSN 1798-2448) Welch disclosed an approach to improving the probability of knowing which slit, in a double slit system, a photon or particle passed in formation of an interference pattern. Briefly, a reference interference pattern is formed on a reference screen (SC), (see FIG. 3), by firing a multiplicity of photons or particles thereat from a source, (or by calculation). Next a test screen (SC) (again see FIG. 3) is placed nearer to the source than was the reference screen (SC) and a single similar photon or particle is fired there-toward. Next, lines are projected from each slit through the location on the test screen (SC) whereat the single or photon or particle impinged. It was forwarded that the line projection which intercepted the reference pattern at a higher intensity location thereof, indicated the slit (SL1) (SL2) through which it was more likely the single photon or particle passed. While not specifically mentioned in the cited ISAST letter, it is noted that the momentum of the single photon or particle which impinges on the testscreen is set ---exactly--- by the source thereof, and the location at which the single photon or particle impinges on the test screen in measured ---exactly---. That is, there is no inherent Heisenberg-type source of uncertainty in either the identified set momentum or measured position of the single photon or particle that is caused to impinge on the test screen. Hence, in the Heisenberg sense, because the momentum of a photon or particle approaching the slits can be set with unlimited certainty, it is impossible to know anything about its location, hence which slit it passes. As well, since it is possible to measure the position at which the photon or particle impinges on the test screen with unlimited certainty, it is again impossible to know anything about its lateral momentum when it impinged on the test screen. That being the case, again, Heisenbergs principle holds that one cannot know which slit the photon or particle passed in its approach to a test screen.

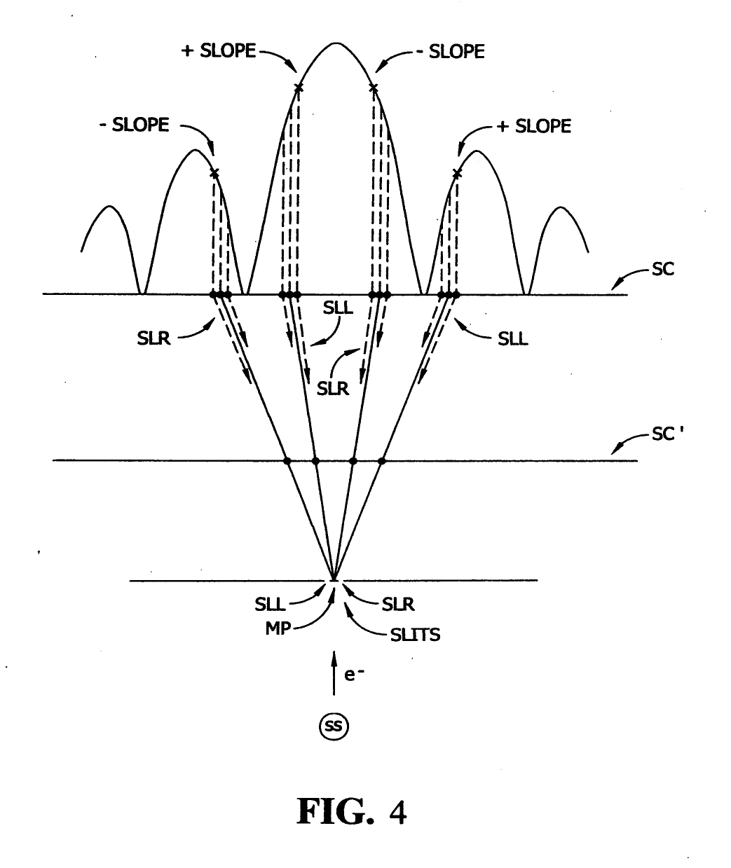

In a paper published in the ISAST Transactions on Computers and Intelligent Systems, No. 1, Vol. 3, 2011 (ISSN 1798-2448), titled The Welch Certainty Principle Welch demonstrated that practice of his method which utilizes a reference pattern as disclosed in The Uncertainty of Uncertainty article, leads to the conclusion that it is always more likely that a photon or particle which proceeds through a left slit, (as viewed from the source thereof), in a double slit system is more likely to contribute to a positive slope region of an interference pattern, and that it is always more likely that a photon or particle which proceeds through a right slit, (as viewed from the source thereof), in a double slit system is more likely to contribute to a negative slope region of an interference pattern. This result, it is emphasized, was based on use of a reference pattern to which a photon or particle which impinges on a test screen is compared. (The reference pattern was described as having been formed on a reference screen before the single photon or particle is caused to impinge on the test screen, which reference screen is positioned behind the test screen). The basis for this proposal is that projections from both slits through the position on the test screen at which the single photon or particle impinged, provides insight that one of the projection lines was progressing along a trajectory that would lead it to intersect the reference pattern at a higher probability location thereof. FIG. 4 demonstrates the scenario just described. Note that a reference pattern is shown as present on screen (SC), and that four lines therein are projected from the center point between the slits (SLL) and (SLR) through four points on test screen (SC), such that they project to beneath positive (+) and a negative (−) slope regions on each of the right and left sides of the interference pattern. To reduce clutter, associated with each of said centerline projections are shown only partial projected lines to each of the slits (SLL) and (SLR), with that corresponding to the highest intensity location on the reference interference pattern on screen (SC) identified. FIGS. 5a and 5b are included to aid with visualizing the significance of the slopes associated with both the projections from the slits through a point on screen (SC) and of the reference pattern on screen (SC). It is specifically noted, as it is critical to understanding the Welch approach, that on either the right or left side of the interference pattern on screen (SC), a line projected through a point on screen (SC) from the left slit (SLL) intercepts a location on screen (SC) associated with a higher intensity of a positive slope region of the reference interference pattern, and a line projected through a point on screen (SC) from the right slit (SLR) intercepts a location on screen (SC) associated with a higher intensity of a negative slope region of the reference interference pattern. It was also previously disclosed that as the test screen (SC) can be a very small distance dx in front of the reference screen (SC), it can be projected that if an interference pattern is simply formed on a screen one photon or particle at a time, it can be concluded that if a photon or particle contributes to a positive slope region of the emerging interference pattern, it more likely passed through the FIGS. 5a and 5b show slopes of line left slit (as viewed from the source), and if it contributes to a negative slope region in the emerging interference pattern it more likely passed through the right slit (as viewed from the source). And, importantly, there is no Heisenberg-type uncertainty associated with this knowledge. This is in direct contradiction to the Heisenberg principle as it provides some knowledge as to which slit in a double slit system a photon or particle passes, where the momentum thereof as it approached the slits was set with unlimited certainty. It is suggested that application of the reference Interference pattern in the Welch approach provides that the measurement of position of a single photon or particle on the test screen, with unlimited certainty, adds some momentum information to that position measurement. And, realizing that the reference screen (SC) can be a dx away from the test screen (SC), as dx goes to 0.0, this provides insight that the measurement of position of the single photon or particle on the test screen directly includes effective inherent momentum information. And this inherent momentum information is sufficient to provide a certain knowledge that it is more likely that the single photon or particle being considered passed through one of the slits. This, again, is in violation of the Uncertainty Principle as it is presently interpreted. It is emphasized that the described Welch approach can be considered as practiced in a double slit system comprising a distance between the slits (SLL) (SLR) and the test screen (SC) which is the minimum consistent with formation of an interference pattern, (as opposed to two diffraction patterns, one for each slit), and the distance from test screen (SC) and screen (SC) upon which is formed the reference interference pattern can be considered as dx, (where dx approaches 0.0). The important point is that the relationship between the various slopes of the lines projected from the slits through a point on test screen (SC) to reference screen (SC), and the slopes associated with the reference interference pattern on reference screen (SC) remains unchanged. Further, as the distance dx test screen (SC) and screen (SC) upon which is formed the reference interference pattern can be considered as essentially 0.0, one can recognize that an interference pattern being formed one photon or particle at a time on test screen (SC) as being formed by a photon or particle which most likely passed through left slit (SLL) if it contributes to a positive (+) slope region of the forming interference pattern, and as being formed by a photon or particle which most likely passed through right slit (SLR) if it contributes to a negative (−) slope region of the forming interference pattern. (Note, FIGS. 3-5 express an after the fact, of a photon or particle impinging on a screen approach to showing which slit (SLL) (SLR) it is more likely a photon or particle passed in the forming of an interference pattern, which approach makes use of a reference interference pattern on a reference screen (SC)), (at least in its derivation).

### Additional Challenge to the Uncertainty Principal

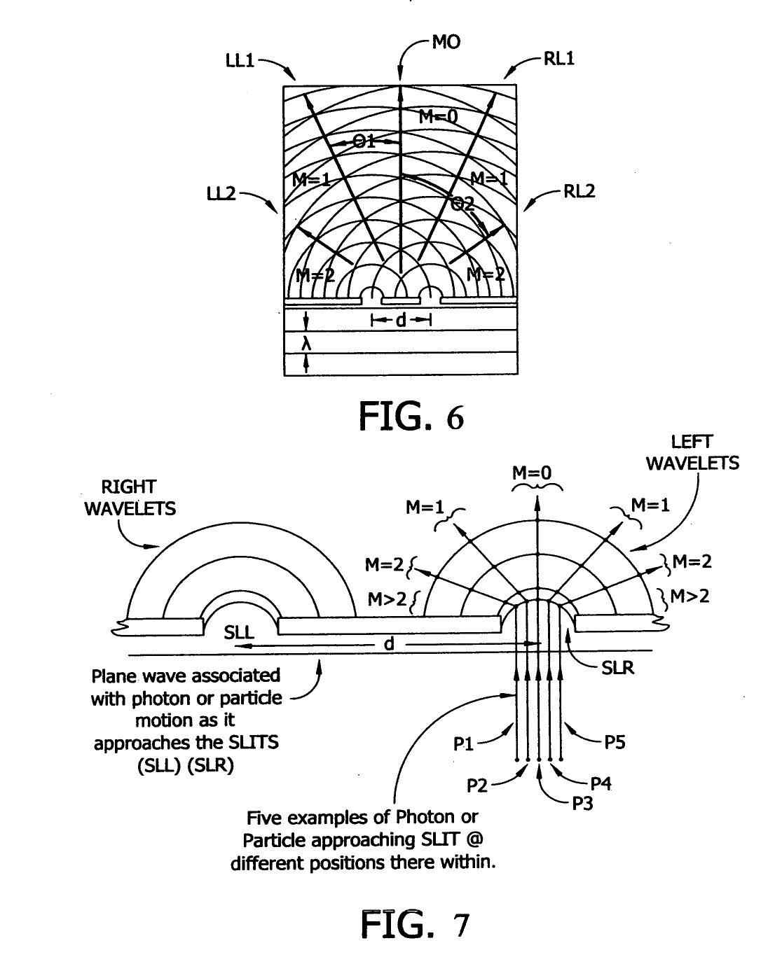

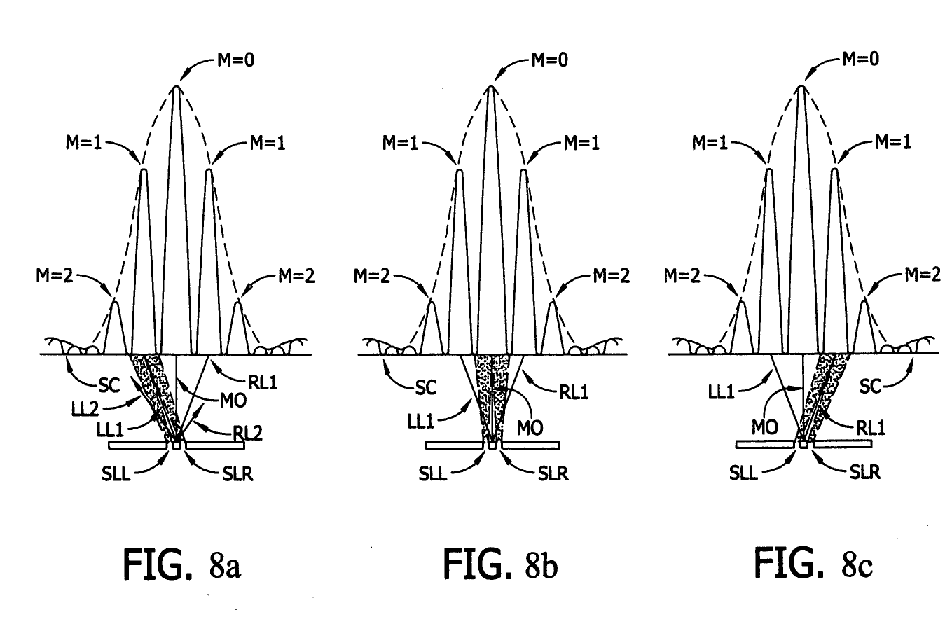

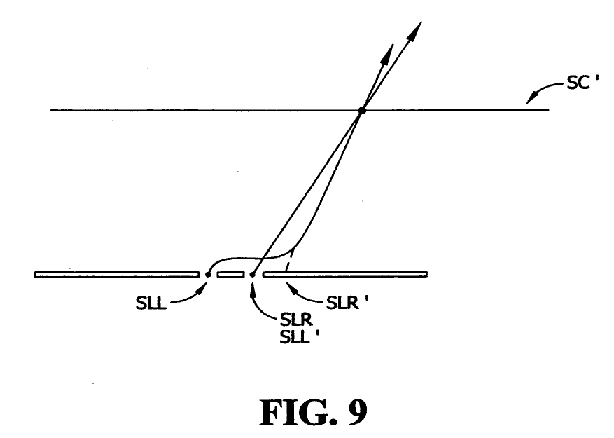

With the foregoing review in mind, attention is now turned to a before the fact, of a photon or particle impinging on a screen (SC) (SC), approach to arriving at the same result as described in the foregoing after the fact approach. This results from focusing on application of Chaos properties to photons or particles that pass through a slit of a double slit system. That is, the foregoing after the fact approach utilizes a reference pattern and looks at the situation after the fact of a photon or particle impinging onto a test screen, while the following looks at situation before a photon or particle impinges on a screen in formation of an interference, in light of Chaos effects at a slit. Turning now to FIG. 6, there is shown a well known pattern of interfering wavelets, wherein, simultaneously, one thereof passes through a left slit of a double slit system and the other through the right slit thereof, and with one thereof is associated the photon or particle. Note that (M=O), (M=1) and (M=2) identifiers are present. Said identifiers pertain to where in a resulting interference pattern peaks appear, and lines (M0) (LL1), (LL2), (RL1) and (RL2) project to peak locations in an interference pattern formed on a screen such as (SC) in FIGS. 1 and 2. FIG. 7 demonstrates how a photon or particle passing through a slit, in view chaos effects based on initial conditions as to where in the width of the slit the photon or particle is as it passes therethrough, will be more likely to follow along an (M=0), (M=1) or (M=2) etc. path. The important thing to notice is that angles (θ1) and (θ2) in FIG. 6 are centered at the midpoint between the slits (SLL) and (SLR), and that lines (M0) (LL1), (LL2), (RL1) and (RL2) project to peak locations on a screen (SC), while slits (SLL) and (SLR) are offset from that midpoint to the left and right respectively It is proposed that photons or particle exiting slit (SLL) will more likely stay to the left of lines (M0), (LL1), (LL2), (RL1) and (RL2) and that a photon or particle exiting slit (SLR) will more likely stay to the right of lines (M0), (LL1), (LL2), (RL1) and (RL2) as they approach a screen (SC). FIGS. 8a 8c show that a likely consequence of this is that a photon or particle exiting the left slit (SLL) will contribute to a positive slope region in an interference pattern and that a photon or particle exiting the right slit (SLR) will contribute to a negative slope region in an interference pattern as was determined with respect to the after the fact scenario wherein a reference interference pattern on a reference screen (SC) was applied to determine the same conclusion. This is not to be taken to mean that it is absolutely impossible for a particle exiting a left slit (SLL) to contribute to a negative slope region of an interference pattern, or for a photon or particle exiting a right slit (SLR) to contribute to a positive slope region, but rather is meant to indicate that the author knows of no forces that could cause that to occur. As described in previously published ISAST article titled The Welch Certainty Principle (2), with respect to FIG. 4 therein, (repeated as FIG. 9 below), to arrive at such a result would require photons or particles follow a very unnatural path after leaving a slit (SLL) (SLR). As discussed in the The Welch Certainty Principle (2), if a photon or particle could travel between a slit (SLL) SLR) to a screen (SC) (SC) along a path as shown in FIG. 9, the result would be to invert the interpretation promoted herein in the after the fact approach. A similar adverse result would attach in the before the fact approach as it would not be more likely that a photon or particle would travel along a more direct path that would keep it to the left of a line or right of a line (M0) (LL1), (LL2), (RL1) and (RL2) for left and right slits (SLL) and (SLR), respectively. It has been suggested that particles present between the slits and Screen (SC′) could cause scattering leading to a FIG. 9 scenario.

However, this is simply a limits of experimental equipment objection. With a sufficient vacuum present in the experimental system, and with the Test Screen (SC′) placed at the smallest possible distance from the Slits (SLL) (SLR) which is consistent with formation of an interference pattern, this objection is not considered to be fatal to the proposal herein.

### Proposed Experiment

Finally, as Science always seeks experimental verification of any theoretical proposal, it is suggested that a verifying experiment could be performed with a double slit system comprising a test screen (SC), (not the slits as proposed and rejected in Feynman, mounted so that it can, in a monitorable manner, move to both the left and right, and return to a central location between tests. If a test particle impinges upon such a screen it will impart its lateral momentum thereto and the screen will move. Further, FIG. 4 indicates that a particle exiting the left slit (SLL) and proceeding to the right has a greater lateral component than does a particle exiting the right slit (SLR) and moving to the right, and that a particle exiting the right slit (SLR) and moving to the left has a greater lateral component than does a particle exiting the left right slit (SLL) and moving to the left. Therefore it is proposed that a particle exiting the left slit (SLL) and contributing to a positive (+) slope region in the Interference Pattern to the right of its Center will cause the test screen (SC) to move more than will a particle exiting the right slit (SLR), and that a particle exiting the right slit (SLR) and contributing to a negative (−) slope region in the Interference Pattern to the left of its Center will cause the test screen (SC) to move more than will a particle exiting the left slit (SLL). (Note, the exact position at which the particle impinges on the screen ---and--- the momentum with which it arrives thereat (as indicated by test screen (SC) movement), would be simultaneously measured). Further, the relative value of the momentum, as indicated by the amount by which the test screen (SC) moves, would indicate which slit the particle passed. Ideally, as FIGS. 6a 6c suggest, every particle exiting a left slit or right slit will be identified by the amount of momentum they impart to the test screen (SC) at the point upon the Interference Pattern to which they contribute. That is, ideally, every particle exiting the left slit (SLL) and proceeding to the right will contribute its momentum to a positive (+) slope region of the interference pattern, and every particle exiting the right slit (SLR) and proceeding to the left will contribute its momentum to a negative (−) slope region of the interference pattern, as indicated by the magnitude of the test screen (SC) movements, but at least that effect should be found to be true on the average. That is, to the right of Center in Interference Pattern, a particle contributing to a positive (+) slope region, (from the left slit (SLL)), should cause a greater test screen (SC) movement than does a particle which contributes to a negative (−) slope region (from the right slit (SLR)); and to the left of Center of the Interference Pattern a particle contributing to a negative (−) slope region (from the right slit (SLR)) should cause a greater test screen (SC) movement than does a particle which contributes to a positive (+) slope region (from the left slit (SLL), if what is presented in this paper is valid. Further, the experiment could be repeated with the test screen at various distances from the slits and a map of momentums developed. This might show unexpected particle motions. And, even if the premise in this paper is not correct, the results of the experiment described would provide valuable insight to what is valid.

It is also proposed that a particle impacting a screen (SC′) which can move along a trajectory perpendicular thereto might also provide an approach to measuring position and momentum substantially simultaneously. The position will be indicated by the point of initial impact, and momentum by screen (SC′) movement. If a screen (SC′) could be constructed to allow combined lateral and perpendicular motion, that would also provide a valuable experimental tool.

### CONCLUSION

Two approaches point to the conclusion that it is possible to know which slit of a double slit system it is more likely that a photon or particle (having known, with certainty, momentum as it approaches the slits), passed in the formation of an interference pattern. One approach is termed after the fact and the other before the fact, (of a photon or particle impinging on a test screen). The after the fact approach involves application of a reference interference pattern, at least in derivation of the approach, and is based on observing where, in an emerging interference pattern, a photon or particle contributes thereto, (ie. where a photon or particle impinges on a test screen). The before the fact approach looks to chaos effects, based on where a photon or particle is within the width of a slit it passes through, and how a photon or particle passing through a slit is encouraged by interfering wavelets from the two slits to proceed toward one or another of the peak regions in an interference pattern. Both approaches lead to the same conclusion that it is more likely a photon or particle passes through the left slit (as viewed from the source thereof), of a double slit system, if it contributes to a positive slope region of a formed or forming interference pattern, and it is more likely that the photon or particle passes through the right slit if it contributes to a negative slope region thereof. An experiment, which could allow simultaneous measurement of particle position and momentum to test the proposal, is also suggested. Further, the Heisenberg Uncertainty Principle as conventionally presented, is an Absolute. That is, if one knows, for instance, the position/momentum of a photon or particle exactly, then the uncertainty in the knowledge of its momentum/position is infinite. It is suggested that this is not valid and that consideration of system-specific characteristics in a double slit setting can allow one to know more about the location and momentum of a photon or particle which contributes to formation of an interference pattern therein, than is allowed by the Heisenberg formulation. This is in the form of an improved knowledge of which slit (SLL) (SLR) it is ---more likely--- that a photon or particle passed when it contributed to formation of an interference pattern. It is suggested that a physical system-specific approach to reformulating the uncertainty principle should be considered in other physical systems as well. An experiment, which, if physically possible, could overturn uncertainty is also disclosed.

Finally, even Einstein rejected Quantum Mechanics, believing it was incomplete. Perhaps the foregoing points a pathway to “completing” the topic by adding system-specific particle considerations, to the wave considerations which so very accurately predict an interference pattern, but say nothing as to what a panicle is doing.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breath and scope only by the Claims.

I claim:

1. A method of determining through which slit of a double slit system a particle passes in formation of an interference pattern comprising the steps of:
a) providing a double slit system which comprises:
a′) a source of particles;
a″) a barrier having two slits therein;
a′″) a screen;
such that in use a particle is caused by said source thereof to approach and pass through a slit in said barrier, then impinge on said screen; and such that when a multiplicity of particles are so caused to pass through one or the other slit in said barrier, then impinge on said screen, an interference pattern emerges, said interference pattern having positive and negative slopes on both sides of a center point of said interference pattern;
said screen further having means for allowing lateral motion in response to momentum transfer from an impinging particle;
b) causing said source to project a particle toward said barrier such that it passes through one of the slits and impinges said screen in a manner allowing the position at which is impinges to be identified, as well as how far said screen moves laterally in response to momentum being transferred thereto;
said method further comprising
c) determining that for particles contributing to positive slope regions in the interference pattern to the right of said interference pattern central region and for particles contributing to negative slope regions in the interference pattern to the left of said interference pattern central region that the screen lateral motion is greater than for particles contributing to negative slope regions in the interference pattern to the right of said interference pattern central region and for particles contributing to positive slope regions in the interference pattern to the left of said interference pattern central region; and
concluding therefrom that on both sides of the central region of the interference pattern, particles contributing to positive slope regions predominantly pass through the left slit and that particles contributing to negative slope regions predominantly pass through the right slit, said systems right and left being as viewed from said source.

2. A method of determining through which slit of a double slit system a particle passes in formation of an interference pattern comprising the steps of:
a) providing a double slit system which comprises:
a′) a source of particles;
a″) a barrier having two slits therein;
a′″) a screen;
such that in use a particle is caused by said source thereof to approach and pass through a slit in said barrier, then impinge on said screen;
said screen further having means for allowing motion perpendicular to a lateral locus of said screen in response to momentum transfer from an impinging particle;
b) causing said source to project a particle toward said barrier such that it passes through one of the slits and impinges said screen in a manner allowing the position at which is impinges to be identified, as well as how far said screen moves perpendicular to a lateral locus of said screen in response to momentum being transferred thereto;
said method further comprising:
c) determining how far the screen moves perpendicular to said lateral locus thereof in response to a particle impinging thereupon;
concluding therefrom the location on said screen upon which the particle impinged, and its momentum from the motion thereof how far the screen moves perpendicular to said lateral locus thereof in response to a particle impinging thereupon.
